(19) United States
(12) Patent Application Publication
(10) Pub. No.: US 2008/0181735 A1
(43) Pub. Date: Jul. 31, 2008

(54) Method for manufacturing drill cutters and structure thereof

(75) Inventor: Hsien-Pei Wang, Taipei Hsien (TW)

Correspondence Address: Joe McKinney Muncy, PO Box 1364, Fairfax, VA, 22038-1364, US

(73) Assignee: TING FONG ELECTRIC & MACHINERY CO., LTD.

(21) Appl. No.: 11/657,519

(22) Filed: Jan. 25, 2007

(51) Int. Cl. B23B 27/18

(52) U.S. Cl. 408/144; 76/115

(57) ABSTRACT

A method for manufacturing drill cutters and structure thereof includes forming a base body by forging that has a shank and a barrel which has a plurality of wedging portions at an upper end and forming a barrel-type drill head through powder metallurgy that has a plurality of coupling elements at a lower end corresponding to the wedging portions. The drill head and the base body can be joined together to form a drill cutter which is wear-resisting and does not fracture easily.

### FIELD OF THE INVENTION

The present invention relates to a method for manufacturing drill cutters and structure thereof and particularly to a drill cutter that can rapidly drill hard materials and is wear-resisting and does not easily fracture.

### BACKGROUND OF THE INVENTION

A conventional drill cutter 1 as shown in FIG. 1 has a nib 11 at one end. During drilling debris being generated is carried out through a helical flute 12 formed on the outer wall. Cutting is accomplished through rotation of cutting edges 111 formed radially on the nib 11. For drilling larger holes the cutting edges 111 at a greater distance from the center have to drill a greater range while the cutting edges 111 closer to the center drill a smaller range. As a result, the resistance on the cutting edges 111 is uneven and vibration frequently occurs to the drill cutter. This could cause fracture of the drill cutter 1. Moreover, the drill cutter 1 does not have a debris breaking design. Continuous debris is easily formed that is difficult to remove and clogs the helical flute 12. During drilling a deep hole the drill cutter has to be retracted frequently to clear the accumulating debris. This results in waste of drilling time and a higher fabrication cost.

R.O.C. utility patent No. M260345 discloses a “Cavity drill for railway”. It has a shank and a barrel on a lower side of the shank. The barrel has an annular lower end with a plurality of cutters formed thereon in an equally spaced manner. Each of the cutters has an edge. The peripheral wall of the barrel has a plurality of debris channeling flutes adjacent to the cutters. The edge and the axis of the shank form an included angle between 2 and 4 degrees. Such a structure provides a plurality of cutters on the periphery of the barrel to perform drilling and is an improvement over the drilling with the cutting edge mentioned previously. The drilling range of each cutter is same and no cutter vibration occurs. For drilling a given hole of the same diameter, the resistance is smaller and debris also is less. However the drill cutter has to be made by harder materials (such as tungsten steel). It is more expensive. To save material only the cutters located on the periphery of the barrel are formed by the tungsten steel. The rest portion is made of stainless steel. To do this the tungsten steel cutters have to be soldered individually on the peripheral wall of the barrel. A great care and effort has to be taken to form the included angle between the cutter edge and axis of the shank. Fabrication process is complex and tedious. Variations of cutter elevation caused by soldering easily occur and defects are higher. This results in a lot of wastes. Moreover, during high speed drilling high temperature takes place and the soldering juncture of the cutters and the barrel becomes not stable. Cutters could be loosened off and become useless. Furthermore, it also does not resolve the debris non-breaking problem previously discussed. More improvements are still needed.

Refer to FIG. 2 for another conventional drill cutter adopted a different design. It has a shank 21 and a barrel 22 on the shank 21. The barrel 22 has a plurality of cutters 23 located on an annular upper end that are equally spaced from one another. Each of the cutters 23 has an edge 231 and a debris breaking surface 232. The peripheral wall of the barrel 22 has a plurality of debris channeling flutes 24 adjacent to the cutters 23. To overcome the problems mentioned above, the same material (high speed steel) is used to fabricate the edge 231, barrel 22 and shank 21 in an integrated manner. Vibration of the cutter is eliminated. With the edge 231 and debris breaking surface 232 formed on each cutter 23, debris can be discharged through the debris channeling flutes 24. The debris breaking surface 232 is located behind the edge 231 so that the debris can hit the debris breaking surface 232 and ruptures. Forming of continuous debris and clogging of the debris channeling flutes 24 can be prevented. As it is formed integrally, fabrication is easier and the cost can be reduced. But since it is made of high speed steel, the material cost is higher. Moreover, the high speed steel is hard and brittle. In some countries, especially Asian countries, the steel produced to be drilled is mostly not very pure and has uneven hardness. The drill cutter frequently fractures during drilling operation. This causes a lot of troubles. Hence how to manufacture drill cutters to provide desired performance and durability at an affordable cost is still an issue remained to be resolved.

### SUMMARY OF THE INVENTION

Therefore the primary object of the present invention is to solve the aforesaid problems by providing a novel method to fabricate drill cutters easier at a lower cost.

To achieve the foregoing object, the method of the invention is first forging a solderable metal (such as chromium molybdenum steel) to form a base body which has a shank and a barrel on an upper side of the shank that has a plurality of wedging portions on an upper end and a plurality of helical debris channeling flutes of a selected depth on the peripheral wall thereof; forming a barrel type drill head that has coupling elements on a lower end corresponding to the wedging portions and a plurality of cutters on an upper end thereof; wedging the coupling elements on the wedging portions; and soldering the juncture of the base body and the drill head to form a finished product of a drill cutter.

Another object of the invention is to provide a drill cutter that can easily cut hard materials (such as thick steel plates) and is wear-resisting, easy to discharge debris and does not easily fracture.

The structure of the invention includes a base body and a drill head. The base body has a shank and a barrel located on an upper end of the shank. The barrel has a plurality of wedging portions on an upper end and a plurality of helical debris channeling flutes of a selected depth on the peripheral wall thereof. The drill head is formed in a barrel type and has a plurality of coupling elements on a lower end corresponding to the wedging portions and a plurality of cutters on an upper end thereof spaced from one another in an equally spaced manner. The coupling elements are wedged on the wedging portions to form a drill cutter.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a perspective view of a conventional drill cutter.

FIG. 2 is a perspective view of another conventional drill cutter.

FIG. 3 is a block diagram of the method for manufacturing drill cutters of the invention.

FIG. 4 is an exploded view of the drill cutter of the invention.

FIG. 5 is a schematic view of the drill cutter of the invention in a coupling condition.

FIG. 6 is a perspective view of a finished product of the drill cutter of the invention

### DETAILED DESCRIPTION OF THE PREFERRED EMBODIMENTS

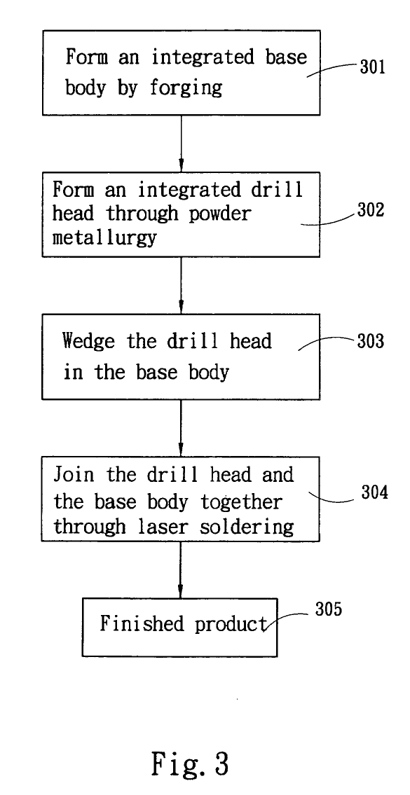

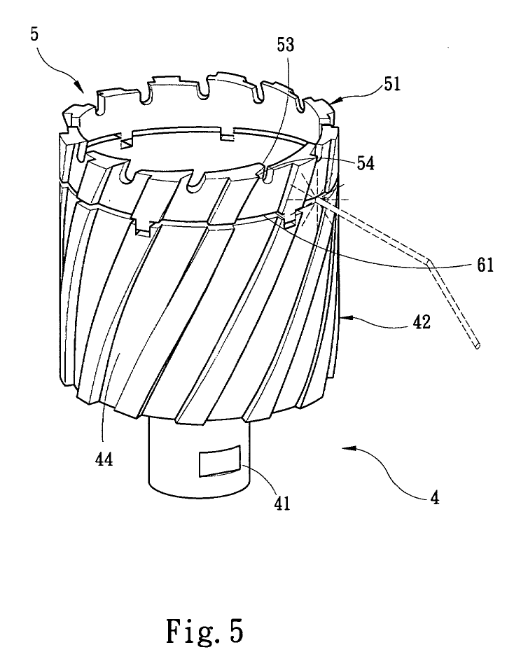

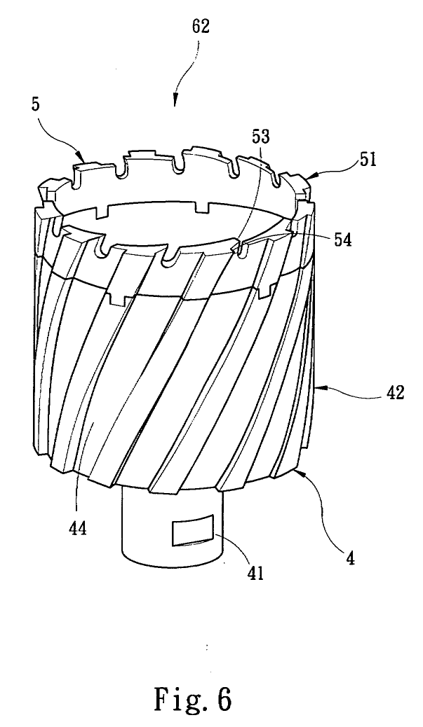

Please refer to FIGS. 3 through 6 for the method for manufacturing drill cutters of the invention and the structure thereof. The drill cutter of the invention aims to rapidly drill hard materials such as wide edge I beams and thick steel plates used on buildings. The method includes: (301) first, forging a solderable metal (such as chromium molybdenum steel, stainless steel and the like) to form a base body 4 in an integrated manner that has a shank 41 and a barrel 42 on an upper side of the shank 41. The barrel 42 has a plurality of wedging portions 43 on an upper end and a plurality of helical debris channeling flutes 44 of a selected depth on the peripheral wall thereof; (302) forging a wear-resisting metal (such as tungsten steel) through powder metallurgy to form an integrated drill head 5 that has another barrel 51 and a plurality of coupling portion 52 on a lower end corresponding to the wedging portions 43 and a plurality of cutters 53 and debris breaking cutters 54 on an upper end thereof; (303) wedging the coupling elements 52 on the wedging portions 43; (304) soldering (such as laser soldering) on a juncture 61 formed between the base body 4 and the drill head 5 to connect them together to form (305) a finished product of a drill cutter 62. The drill cutter 62 thus formed can be easily fabricated and is wear-resisting. The debris channeling flutes 44 have a desired depth and can easily discharge and break debris.

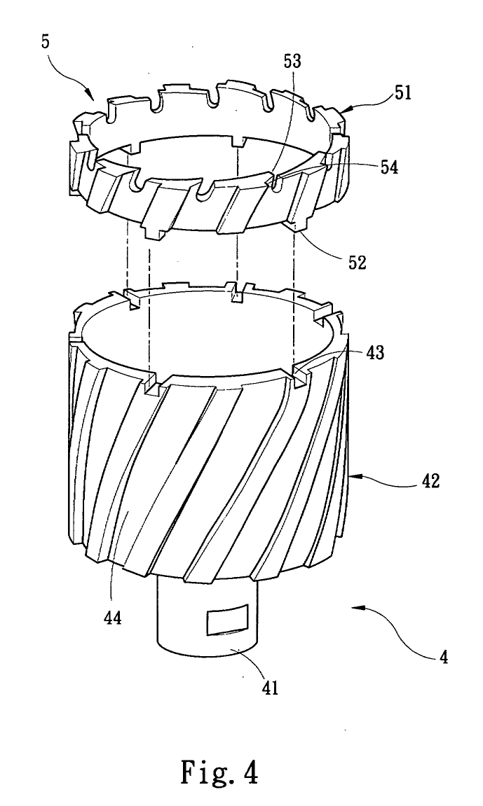

Refer to FIGS. 4, 5 and 6 for the structure of the drill cutter 62 in association with the method previously discussed. The structure includes a base body 4 and a drill head 5. The base body 4 is made of metal which has a relative great plasticity (such as chromium molybdenum steel, stainless steel or the like). Thus it does not easily fracture and is less expensive. The base body 4 has a shank 41 and a barrel 42 at an upper side of the shank 41. The barrel 42 has a plurality of wedging portions 43 on an upper end and a plurality of helical debris channeling flutes 44 of a selected depth on the peripheral wall thereof. The drill head 5 has another barrel 51 and a plurality of coupling elements 52 on a lower end and a plurality of cutters 53 and debris breaking cutters 54 on an upper end thereof that are equally spaced from one another. The cutters 53 and debris breaking cutters 54 have respectively an edge of a selected angle to drill a hole, discharge debris and break the debris simultaneously.

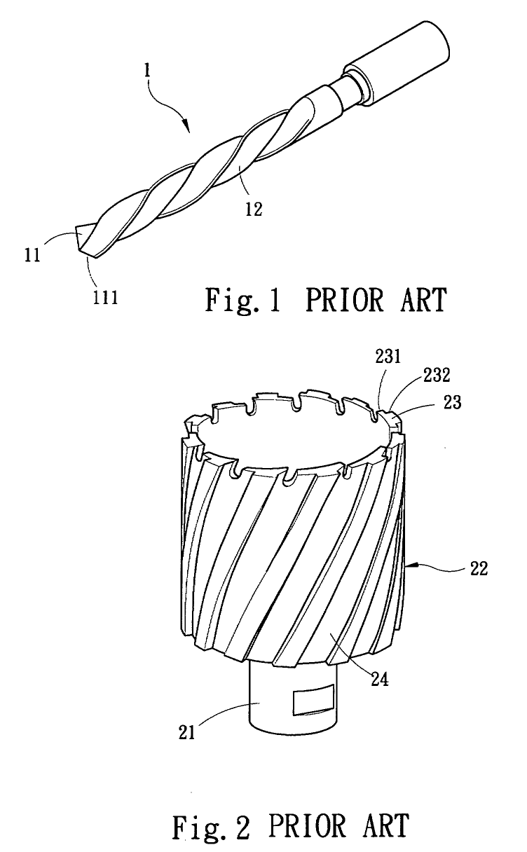

The coupling elements 52 are wedged in the wedging portions 43 such that the base body 4 and the drill head 5 are joined at a juncture 61. Then the base body 4 and drill head 5 are soldered together (such as by laser soldering) to form the drill cutter 62. As the drill cuter 62 is hollow, and has the characteristics of wear-resisting of the tungsten steel and integrated forming of the chromium molybdenum steel, drilling speed of the invention can be about ten times faster than the conventional drill cutter 1 shown in FIG. 1. The invention also can be fabricated easier, is wear-resisting and can discharge debris easily.

Referring to FIG. 4, the wedging portions 43 may be notches, while the coupling elements 52 may be tenons to be wedged in the notches to join the base body 4 and the drill head 5 together.

The wedging portions 43 may also be tenons and the coupling elements 52 may be notches to be coupled with the notches to join the base body 4 and the drill head 5 together.

In short, the method for manufacturing the drill cutter 62 of the invention and the integrated structure thus formed consists of the drill head 5 and the base body 4 that are joined together by laser soldering. Fabrication is easier. The base body 4 can be made at a lower cost. The drill head 5 has a higher hardness and is wear-resisting. The debris channeling flutes have a sufficient depth to discharge and break debris easily. By coupling the drill head 5 and the base body 4 together, a novel characteristic and enhanced performance can be achieved. It offers a significant improvement over the conventional products.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A method for manufacturing a drill cutter which is wear-resisting and easy to discharge and break debris, comprising the steps of:
a. forming an integrated base body by forging a metal that has a shank and a barrel at an upper side of the shank, the barrel having a plurality of wedging portions at an upper end and a plurality of helical debris channeling flutes of a selected depth on the peripheral wall thereof;
b. forming a barrel-type drill head from another metal through powder metallurgy that has a plurality of coupling elements at a lower end corresponding to the wedging portions and a plurality of cutters and debris breaking cutters at an upper end thereof,
c. wedging the coupling elements in the wedging portions; and
d. forming a juncture between the base body and the drill head, and joining the base body and the drill head together by soldering to form a finished product of the drill cutter.

2. The method of claim 1, wherein the base body is made of chromium molybdenum steel.

3. The method of claim 1, wherein the drill head is made of tungsten steel.

4. The method of claim 1, wherein the soldering is laser soldering.

5. A drill cutter comprising:
a base body which has a shank and a barrel at an upper side of the shank; the barrel having a plurality of wedging portions at an upper end and a plurality of helical debris channeling flutes of a selected depth on the peripheral wall thereof; and
a barrel-type drill head which has a plurality of coupling elements at a lower end and a plurality of cutters and debris breaking cutters at an upper end thereof;
wherein the coupling elements are wedged in the wedging portions to form the drill cutter which is wear-resisting and easily fabricated, and discharges and breaks debris easily.

6. The drill cutter of claim 5, wherein the coupling elements are tenons and the wedging portions are notches.

7. The drill cutter of claim 5, wherein the coupling elements are notches and the wedging portions are tenons.

8. The drill cutter of claim 5, wherein the cutters and the debris breaking cutters have respectively an edge at a selected angle.
